(19) United States
(12) Patent Application Publication
(10) Pub. No.: US 2017/0011901 A1
(43) Pub. Date: Jan. 12, 2017

(54) Methods of Optimizing Ion Transmission Between Differentially Pumped Vacuum Chambers

(71) Applicants: William (Wei) Yang, Los Altos, CA (US); Ming Chai, Union City, CA (US); Yang Cui, Santa Clara, CA (US)

(72) Inventors: William (Wei) Yang, Los Altos, CA (US); Ming Chai, Union City, CA (US); Yang Cui, Santa Clara, CA (US)

(73) Assignee: BAYSPEC, INC., San Jose, CA (US)

(21) Appl. No.: 14/791,500

(22) Filed: Jul. 6, 2015

(51) Int. Cl. H01J 49/06

(52) U.S. Cl. CPC H01J 49/067; H01J 49/062

(57) ABSTRACT

Apparatus and methods for optimizing the transmission of ions between two differentially pumped vacuum chambers. Ion transmission from the higher pressure vacuum chamber into the lower pressure vacuum chamber is maximized while gas conductance between the chambers is minimized. The conventional single hole circular aperture between adjacent vacuum chambers is replaced with an interface comprising a plurality of smaller apertures configured according to a calculated hole pattern. The individual apertures of the new interface may preferably be arranged in a circular fashion, providing both adequate ion transmission and lower gas conductance. Another embodiment of the invention comprises a surface having a single aperture whose shape comprises a contiguous collection of individual aperture shapes.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### FIELD OF THE INVENTION

The invention relates to the transmission of ions between adjacent vacuum chambers, primarily for the purpose of transferring ions from a higher pressure region to a lower pressure region. The invention finds its greatest application in the field of mass spectrometry, but may also be used in any application where it is desired to maximize ion transmission between differentially pumped vacuum chambers while simultaneously minimizing the gas conductance between those vacuum chambers.

### BACKGROUND OF THE INVENTION

The transfer of ionized molecules between vacuum chambers maintained at different pressures is an important technology in the practice of mass spectrometry, particularly where the chemical sample has been ionized at atmospheric pressure and must ultimately be transferred to an analyzer residing in a vacuum chamber maintained at a pressure many orders of magnitude below atmospheric pressure.

Fundamentally, the practice of mass spectrometry involves the manipulation and control of individual molecules of a substance to determine the mass-to-charge ratio, the chemical formula, the chemical structure, the isotopic ratio, the relative concentration and the amount of a specific compound present in a sample. Typically, a mass spectrometer performs this analysis by first placing the sample molecules into an ionized state. Once the molecules are ionized, they may be controlled through the application of external electric and/or magnetic fields. The behavior of the ionized molecules can then be recorded and analyzed in a variety of ways to determine their mass/charge ratios and the mass/charge ratios of the fragments formed from the breakup of the original molecules of the sample. From this basic mass/charge data, information relating to the formula, structure, isotopic ratio and amount of material present can be calculated or deduced.

The mass spectrometer itself is composed of several different components, often operating under different pressures and different temperatures. A typical mass spectrometer includes an inlet, or separation system, within which the sample to be analyzed is separated into its fundamental chemical components prior to being mass analyzed. The separation device (typically a gas or liquid chromatograph), performs a chemical separation process and then directs the components of the sample into an ion source. The ion source is used to place the sample molecules into an ionized state, whereupon the individually charged molecules may be controlled through use of externally applied electric and/or magnetic fields.

After the ionized molecules leave the ion source they are directed into the analyzer, where the mass/charge ratios of the individual molecules will be measured. This analysis step may involve the use of a single or multiple set of quadrupole rods, a magnetic and/or electric analyzer, an ion trapping device, an ion mobility cell, a time-of-flight measuring device, or any combination or concatenation of these and other analyzers.

After passing into the analyzer of the mass spectrometer the ions are then detected. The detection process may involve the use of an electron multiplier, a Faraday cup, or a special charge-coupled device detector. The ion detection process may even involve the measurement of image currents generated externally to the analyzer due to the cyclic movement of the ions within the analyzer.

As ions travel between sequential stages of the mass spectrometer, it is important that the ions be properly contained and directed as efficiently as possible through use of various focusing lenses or ion guides, since any loss of ions will result in a proportional loss of signal intensity. While this will not always be fatal, there are many applications where this will mean the difference between detecting a compound and not detecting the compound, or in assigning a concentration or amount to a particular compound that is not correct.

The transport of ions between the various stages of the mass spectrometer is therefore a very critical part of its operation, especially when the transport is between two vacuum chambers having vastly different pressures or temperatures. This is especially true for mass spectrometers that employ ion sources operating at atmospheric pressure coupled to analyzers operating at pressures many orders of magnitude below atmospheric pressure.

The transport of ions from a first vacuum chamber to a second vacuum chamber requires that ion transmission be maximized, while gas conductance between the vacuum chambers be minimized. This presents the conflicting requirements that the size of the aperture used to transport ions between adjacent vacuum chambers be maximized to allow for the largest transfer of ions, and hence the largest sensitivity for the instrument, while also requiring that the size of the aperture be minimized to limit the gas flow between chambers. The gas flow between adjacent vacuum chambers ideally needs to be minimized to reduce the overall pumping requirements of the instrument, and to permit the final analyzer stage to ultimately be maintained at an effective operating pressure.

For many mass spectrometers commercially available, there are often several vacuum chambers placed in a serial configuration to permit the vacuum pressure in each successive chamber to be steadily reduced until an acceptable vacuum for operating the analyzer is obtained. For example, a patent by Bier (U.S. Pat. No. 5,750,993) describes an atmospheric pressure ion source in one chamber, followed by two separate vacuum chambers containing separate ion guides, followed by another vacuum chamber containing the mass spectrometer analyzer itself.

Vacuum chamber manifolds typically have significant size and weight, and require the operation of heavy, expensive vacuum pumps to maintain a sufficiently low pressure to operate the mass spectrometer. The requirements for maintaining proper vacuum conditions in a mass spectrometer employing atmospheric pressure ionization typically involves a significant amount of vacuum system pumping capacity and hardware.

While the vacuum and pumping requirements for a typical bench top mass spectrometer employing atmospheric pressure ionization (API) is significant, it becomes an even larger burden for a portable mass spectrometer. The portable mass spectrometer represents a situation where the mass spectrometer is brought to the sample, as opposed to bringing the sample to the mass spectrometer. This often requires the sample to be ionized at atmospheric pressure, where it is found, and then mass analyzed by the portable instrument at a pressure many orders of magnitude below atmosphere.

In addition to the various design challenges involved in constructing a portable mass spectrometer, it becomes even more challenging to construct the vacuum system for a portable mass spectrometer that is capable of transferring a sufficient quantity of sample ions, generated at atmospheric pressure, to an analyzer operating at many orders of magnitude below atmosphere.

However, for both benchtop and portable mass spectrometers that employ atmospheric pressure ionization of the sample, the basic challenge remains that ion transmission between adjacent vacuum chambers be maximized, while the gas conductance between adjacent vacuum chambers be minimized.

### SUMMARY OF THE INVENTION

The typical ion interface connecting sequential vacuum chambers in a mass spectrometer system, through which sample ions pass, is a simple circular hole, normally in the range of 1 to 2 mm in diameter. A circular hole has traditionally been used under the assumption that ions flowing from the exit of an ion guide are primarily a bundle of ions all flowing parallel to the longitudinal axis of the ion guide itself. (In the context of this patent, an ion guide refers to any ion transmission device that transfers, or generates, ions and transfers them into an adjacent vacuum chamber. This may include a conventional ion guide, an ion funnel, an ion tunnel, a stacked ring ion guide, a quadrupole, a hexapole, an octopole, or any other ion transmission or ion generation device.)

However, the ion flow exiting from an ion guide is typically not a bundle of ions all emerging with trajectories parallel to the longitudinal axis of the ion guide. Generally, the ions that emerge from the exit of an ion guide disperse radially from the longitudinal axis of the ion guide.

There are several reasons for this ion dispersion to occur. First, the region between the exit end of the ion guide and the exit aperture of the enclosing vacuum chamber is normally not subject to any focusing potential in the radial direction, perpendicular to the longitudinal axis of the ion guide. Therefore, the lack of a radial focusing field allows the emerging ions to disperse in a radial direction.

Secondly, the construction of the ion guide, especially in the case of an ion funnel, will typically include a sufficient number of electrodes to reduce the gas conductance from the interior axis of the ion guide outward into the enclosing vacuum chamber. This allows ions exiting from the ion guide to disperse radially due to the decrease in pressure experienced by the ions as they exit the ion guide and flow outward, from a region of higher pressure to a region of lower pressure.

Additionally, depending upon the quantity and mass of the ions flowing through the ion guide, the ions themselves will experience a coulomb repulsion generating additional radial ion dispersion as the ions exit the ion guide.

Finally, one of the most novel features of the described invention is the use of a plurality of smaller apertures to transmit ions from one vacuum chamber to another, as opposed to a larger, single aperture. While the multiple aperture design might appear to severely limit ion transmission due to the reduced aperture area, it actually provides for very efficient ion transmission. The ion guide, or mass analyzer, located in a succeeding, lower pressure vacuum chamber, will normally generate an electric field that will penetrate the individual apertures. This electric field attracts the incident ions emerging from the ion guide, allowing them to pass through the plurality of individual apertures and enter the subsequent lower pressure vacuum chamber.

An important characteristic of the described invention is that the total aperture area of all the individual apertures comprising the ion transmission interface be less than that of a conventional single hole aperture. This allows a multiple aperture interface to function as an effective ion transmission interface between vacuum chambers, while simultaneously providing for a reduced gas conductance between the adjacent vacuum chambers. (For purposes of the patent description, the term “aperture”, unless otherwise described, will normally refer to an opening, having any shape, in a surface. The opening will penetrate from one side of the surface to the other, allowing particles to pass through the surface.)

In another embodiment of the invention, an ion transmission interface may be constructed from a surface having a single aperture, in which the transmission area through which the ions may pass is less than the total surface area of the ion interface device. In this manner, an ion interface may be constructed from a contiguous collection of areas, through which ions may pass, having circular, rectangular, or elliptical shapes.

The ability to effectively transfer ions between adjacent vacuum chambers, while simultaneously reducing gas conductance, has application for both bench-top mass spectrometers and portable mass spectrometers. In the case of the bench-top mass spectrometer, where the final analyzer stage would typically be operated at a pressure below 1 milli-Torr, the ion transmission interface described here could be used to reduce the pumping requirement of the instrument, possibly reducing the total number of vacuum chambers required for the instrument, or reducing the size and number of vacuum pumps required. In the case of a portable mass spectrometer, where the pumping capacity is already limited, the ion transmission interface described here could be used to reduce the overall size and weight of the instrument, while still maintaining adequate ion transmission and analyzer pressure.

### BRIEF DESCRIPTION OF THE DRAWINGS

FIG. 1 shows two adjacent vacuum chambers of a mass spectrometer: an ion funnel in the first chamber on the left; and a mass analyzer in the second chamber on the right.

FIG. 2 shows the typical exit flow of ions leaving the exit end of an ion guide.

FIG. 3 shows the prior art, conventional shape of an ion transmission aperture connecting two adjacent vacuum chambers.

FIG. 4 shows an example of a new ion interface design that may be used between adjacent vacuum chambers in a mass spectrometer inlet system, consisting of 5 individual apertures arranged in a circular fashion.

FIG. 5 shows the side view of a tapered hole design, including an ion flow, that could be used as a single aperture in the new interface design connecting two adjacent vacuum chambers.

FIG. 6 shows the side view of ions emerging from the exit end of an ion guide and passing through a multiple aperture interface and into a subsequent vacuum chamber.

FIG. 7 shows an example of a new ion interface design that may be used between adjacent vacuum chambers in a mass spectrometer inlet system, consisting of 5 individual apertures arranged in a circular fashion with an additional circular aperture placed in the center of the interface.

FIG. 8 shows an example of a new interface design that may be used between adjacent vacuum chambers in a mass spectrometer inlet system, consisting of 16 individual apertures spaced equally within a circular area.

FIGS. 9, 10 and 11 are examples of an ion interface design utilizing a single aperture. These three single aperture ion interface designs are similar in function to the multiple aperture ion interfaces displayed in FIGS. 4 and 7, except that the single aperture designs have contiguous sections.

FIG. 12 shows an ion interface device and the dividing wall between two adjacent vacuum chambers.

### DETAILED DESCRIPTION OF THE INVENTION

The primary embodiment of the invention is an improved method of transferring charged molecules from a first vacuum chamber maintained at a given gas pressure to a second vacuum chamber maintained at a lower gas pressure. The improvement is obtained by transferring the charged molecules through a surface, common to both vacuum chambers, comprising a plurality of individual apertures that collectively contain less aperture area than the single hole aperture conventionally used in such an application. However, with proper design of the ion interface, the quantity of ion transmission occurring between adjacent vacuum chambers can be maintained at acceptable levels, or actually increased, despite the reduction in total aperture area through which the ions pass, while the gas conductance between adjacent vacuum chambers is reduced proportional to the reduction in the total aperture area between the two vacuum chambers.

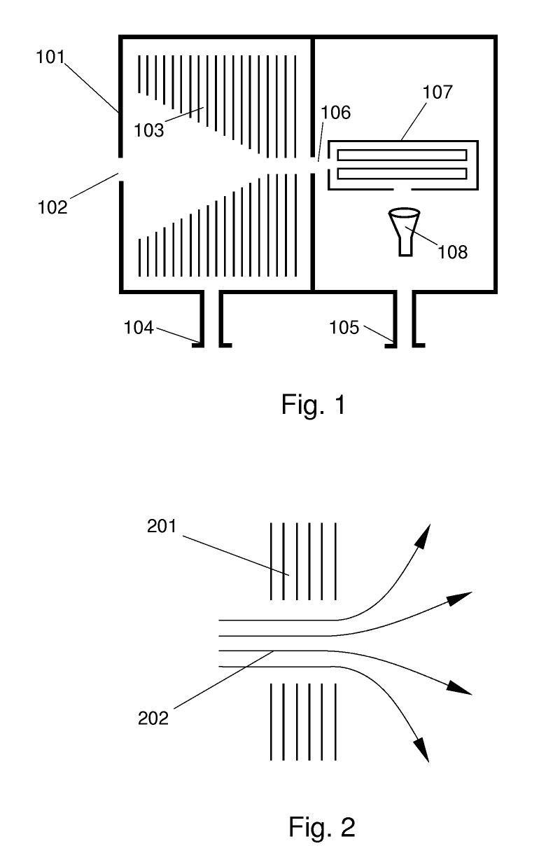

FIG. 1 shows an example of two vacuum chambers that are often utilized in a mass spectrometer. The two vacuum chambers 101 are connected together with an ion funnel 103 in the first vacuum chamber on the left, and a mass spectrometer analyzer 107, with an electron multiplier 108, in the second vacuum chamber on the right. Sample ions are introduced through an aperture 102 in the first vacuum chamber, pass through the ion funnel 103, and are ejected through the connecting aperture 106 into the second vacuum chamber containing the mass spectrometer analyzer 107. The first vacuum chamber is pumped through an interface port 104, and the second vacuum chamber is pumped through a separate interface port 105.

FIG. 2 shows the typical path that charged molecules 202 take upon exiting from an ion guide 201 and entering a region which has no electrostatic field in the radial direction of the emerging ions.

An ion funnel used with a mass spectrometer will typically have an exit aperture on the order of 2 or 3 mm. Therefore, with the normal dispersion of ions exiting from an ion funnel, the aperture interfacing the ion funnel to the subsequent vacuum chamber should have an aperture size of at least 2 or 3 mm to maximize ion transmission into the subsequent vacuum chamber. However, since the tendency of the ions emerging from the ion funnel is to spread radially outwards from the longitudinal axis of the funnel, the majority of the ions ejected from the ion guide will pass through the interfacing aperture near the actual perimeter of the aperture itself.

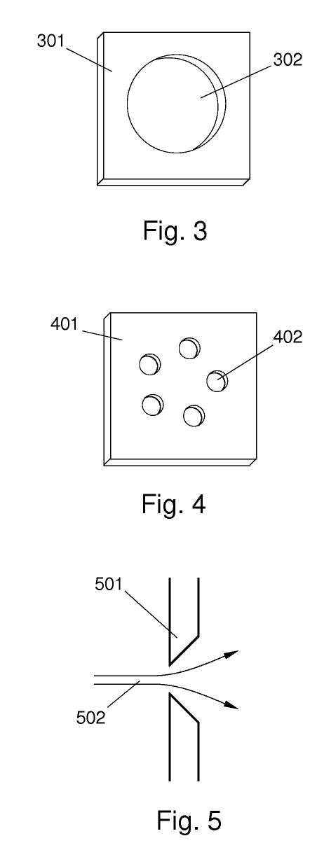

FIG. 3 shows a single surface 301 with a single circular aperture 302, illustrating the conventional ion interface device for transferring ions between adjacent vacuum chambers. FIG. 4 shows a single surface 401 containing five individual apertures 402, arranged in a circular pattern, through which ions may pass from one vacuum chamber to the next.

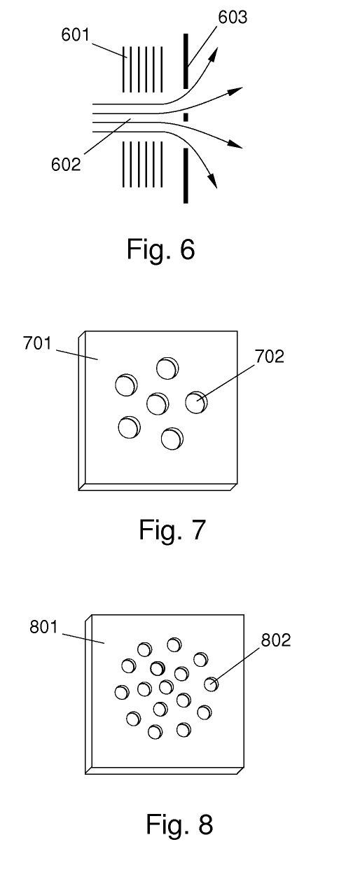

FIG. 6 shows a side view of an ion beam 602 exiting an ion funnel 601 and radially dispersing through the individual apertures in a multiple aperture interface 603.

The individual apertures themselves, such as the apertures 402 shown in FIG. 4, may be constructed with a simple cylindrical design penetrating the surface, or alternatively with a tapered design. FIG. 5 shows a side view of a single aperture 501, as might be used in a multiple aperture interface, with an ion bundle 502 passing through the single aperture. The aperture 501 shown in FIG. 5 is tapered at an angle of approximately 45 degrees. The tapered design represents a preferred embodiment of the invention as it allows the ion interface surface itself to be as much as 2 or 3 times thicker without decreasing the total quantity of ion transmission.

When the thickness of the surface containing an individual aperture is very thin, or is very small in relation to the diameter of the aperture itself, a “thin aperture” condition is achieved. When the “thin aperture” condition applies, the aperture may be treated as being a simple two-dimensional element, connecting two different vacuum chambers, without any need to consider the thickness of the surface itself. The best performance is therefore achieved by using the thinnest interface surface possible, while still maintaining adequate strength to separate adjacent vacuum chambers when normal operating pressure is reached.

The multiple aperture interface described will typically be constructed from a single sheet of stainless steel, titanium, or any other strong metal alloy. The holes in the interface, when employing circular apertures, may be drilled using conventional mechanical drill bits. However, for an ion transmission interface having apertures significantly less than 1 mm in diameter, the apertures may alternatively be created through the use of laser drilling.

The main objective in reducing the total aperture area of the ion interface between adjacent vacuum chambers is to reduce the gas conductance between the adjacent vacuum chambers, thereby allowing the adjacent vacuum chambers to be held at a greater pressure differential, without increasing the pumping capacity of the vacuum system. This is an important objective for any mass spectrometer that employs an atmospheric pressure interface, since sample ions created at atmosphere must ultimately be analyzed in a vacuum chamber maintained at a pressure several orders of magnitude below atmosphere.

To aid in the development of an effective ion interface, we need to calculate the amount of gas conductance that can be achieved with a multiple aperture interface. Originally, the gas conductance will be proportional to the area of the single circular aperture, which is given by:

Aᵢ=π·Rᵢ² (1)

In which Aᵢ is the area of the original single aperture interface and Rᵢ is the radius of the original single aperture interface. The area of the multiple aperture ion interface, assuming the individual apertures have a circular shape and are all the same size, is given by:

Aₙ=N·π·Rₙ² (2)

In which Aₙ is the total area of the multiple aperture interface design, N is the number of individual apertures, and Rₙ is the radius of an individual aperture.

We can define a percentage reduction in the radius of an individual aperture, from the multiple aperture ion interface, with respect to the radius of the original single aperture design as:

Rₙ=P·Rᵢ (3)

In which P is the reduction in radius of the original single aperture design. The reduction in total aperture area of the new multiple aperture design is then given by:

$$\frac{{A}_{n}}{{A}_{i}} = \frac{N \cdot π \cdot {P}^{2} \cdot {R}_{i}^{2}}{π \cdot {R}_{i}^{2}} = N \cdot {P}^{2} \qquad ( 4 )$$

To achieve a reduction in the total aperture area for the multiple aperture ion interface relative to the single aperture design, the ratio of the area of the multiple aperture interface to the area of the original single aperture interface must be less than 1. Which can also be stated as:

N·P²<1 (5)

Then, as a design criteria, we can state a requirement for the reduction factor as follows:

$$P < \frac{1}{\sqrt{N}} \qquad ( 6 )$$

And from equation (4), we then have a general design equation for the multiple aperture interface:

$$\frac{\sqrt{\frac{{A}_{n}}{{A}_{i}}}}{\sqrt{N}} = P \qquad ( 7 )$$

Equation (7) allow us to determine the radius of the individual apertures that are required to achieve a given overall reduction in gas conductance, knowing the total number of individual apertures that will be used in the ion interface. For example, if we have designed an interface for which we would like to have a decreased gas conductance of 50%, and we have a total of 7 individual apertures, we can then calculate the percentage reduction in the individual aperture radius by using Equation (7), as follows: P=(\sqrt{0.50}/\sqrt{7}), which gives us a reduction factor of about 0.27. Therefore, if the original ion interface consisted of a single circular aperture of diameter 2 mm, the multiple aperture interface would consist of 7 individual apertures having diameters of 0.54 mm (2×0.27) each, with a total reduction of gas conductance between the two adjacent vacuum chambers of 50%.

In addition to achieving a reduction in gas conductance between two adjacent vacuum chambers, it is also necessary to determine the proper geometry of the multiple aperture interface that will provide for adequate, or even improved ion transmission. Since the ions which exit from an ion guide, or ion source, will normally disperse radially in all directions, the multiple aperture design will typically need to assume a circular pattern of individual apertures.

The most efficient multiple aperture design for a given ion transmission interface will depend upon several factors. This includes the type of ion guide located in the first vacuum chamber, the electric field generated by the entrance lens for the ion guide or mass analyzer located in the second vacuum chamber, and the energy of the ions emerging from the ion guide located in the first vacuum chamber.

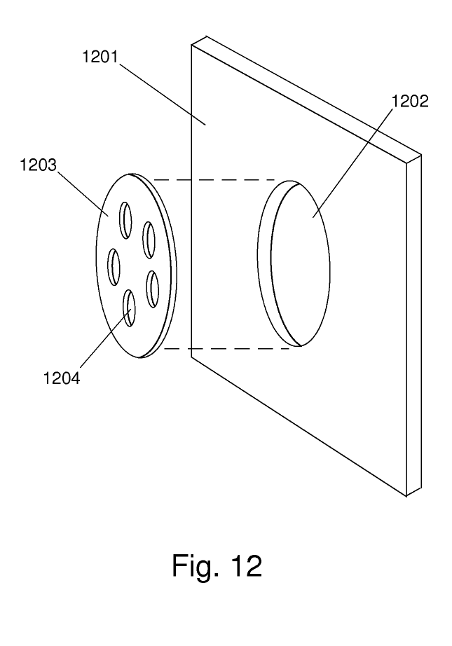

FIG. 12 shows the wall between two adjacent vacuum chambers 1201 and a cutout 1202 in which the ion interface 1203, containing a plurality of individual apertures 1204, will be installed. The ion interface 1203 itself may be any size or shape, as long as it is large enough to contain the collection of individual apertures comprising the new ion interface. The ion interface 1203 may be attached to the vacuum chamber wall 1201 using vented metal screws, or any other method that provides for secure attachment. If the ion interface 1203 is securely attached to the vacuum chamber wall 1201, a gasket may not be needed.

The ion interface 1203 itself should be very thin. It should be no more than 1 mm thick and preferably less than 0.5 mm. It may be constructed from stainless steel, titanium, or any other strong conductive metal or metal alloy. The individual apertures may have a cylindrical shape, or they may be created with a tapered structure as shown in FIG. 5, in which case the ion interface surface may be 1 to 2 mm thick.

The most effective approach for achieving an efficient ion interface design is to first construct an ion interface having five or more circular apertures, with each having approximately the same diameter (within 10%), arranged in a circular fashion, as shown in FIG. 4. As shown in FIG. 12, the interface surface 1203 containing the multiple aperture design can be easily installed for testing without requiring additional machining of the vacuum chamber. Equation (7) should be used to determine the diameter of the individual apertures themselves.

The experimentation required to find the optimum ion transmission configuration will normally involve varying the diameter of the circular ring of individual apertures to determine the diameter which produces the maximum amount of ion transmission. This will be an indicator of the amount of radial dispersion occurring for ions exiting the ion guide in the first vacuum chamber. When that diameter has been determined, the number and size of the individual apertures may then be varied to again obtain the maximum ion transmission. Finally, an additional aperture located in the center of the ion interface disk may be added to determine if a significant number of ions are exiting the ion guide parallel to the longitudinal axis of the ion guide, and are not dispersing radially.

The individual apertures of the ion interface may be arranged in a circular fashion, as shown in FIG. 4, or they may be arranged in a circular fashion with an additional aperture in the very center of the ion interface. This is illustrated in FIG. 7, in which the interface surface is shown at 701 and the individual apertures shown at 702.

In another embodiment of the invention, the individual apertures may be arranged uniformly throughout a circular perimeter, as shown in FIG. 8, in which the interface surface is shown at 801 and the individual apertures shown at 802. In addition to the apertures being arranged in a uniformly spaced manner within a circular perimeter as shown in FIG. 8, it would also be possible to place the apertures at random locations within a given perimeter.

In another embodiment of the invention, the ion interface may comprise a single aperture in the center of the interface surface having one diameter, with an additional collection of apertures each having a different diameter, arranged in a circular fashion around the aperture in the center of the surface.

While the simplest, and easiest method of constructing the ion interface device is to use apertures constructed as circular holes, with all holes having the same diameter, the invention may be practiced having an interface design comprising apertures of different diameters, different shapes, or different configurations.

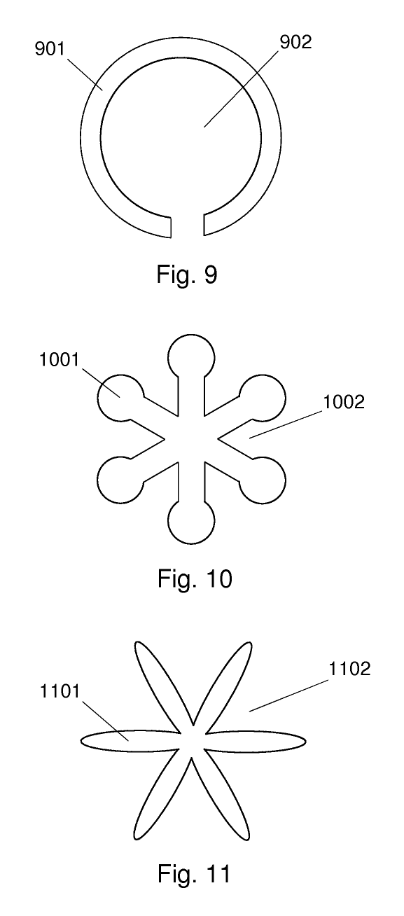

In another embodiment of the invention, the ion interface may be constructed from a single aperture having a plurality of sections, or branches, that are constructed in a contiguous fashion. Examples of such a single aperture interface are shown in FIG. 9, FIG. 10, and FIG. 11. These types of single aperture interfaces are functionally similar to the multiple aperture interfaces previously described, except that all the individual sections of the single aperture interfaces are contiguous.

The single aperture interface show in FIG. 9 comprises an aperture having a circular arc 901, and a surface 902 within which the aperture is cut.

The single aperture interface shown in FIG. 10 comprises an aperture having a contiguous collection of circular shapes and rectangular shapes 1001, and a surface 1002 within which the aperture is cut. In practice, a single aperture interface similar to that of FIG. 10 could be constructed using a plurality of rectangular shapes and a plurality of circular shapes.

The single aperture interface shown in FIG. 11 comprises an aperture having a contiguous collection of elliptical shapes 1101, and a surface 1102 within which the aperture is cut. In practice, a single aperture interface similar to that of FIG. 11 could be constructed using two or more elliptical shapes. Additionally, the shape of the single aperture interface shown in FIG. 11 is very similar to the geometrical shape of many types of plants or flowers found in nature, and many of these natural designs could form the geometrical basis for a single aperture ion interface design.

The examples shown in FIGS. 9, 10, and 11 are different embodiments of the described invention. The number of single aperture designs that are workable is virtually unlimited. The main design criteria for an effective single aperture design is that the actual aperture area, through which the ions pass from one chamber to the next, be less than the surface area of the ion interface device itself.

Most of the multiple aperture ion interfaces previously described could be constructed by machining a series of circular holes at calculated positions, either with a mechanical drill, or a laser. However, the construction of a single aperture interface, such as those illustrated in FIGS. 9, 10, and 11, would typically require the use of a computer controlled milling device, or a computer controlled laser drilling machine.

The multiple aperture ion interface, and the single aperture ion interface, are primarily intended to be used in an inlet system for a mass spectrometer, but they may also be used in any application where it is desired to optimize ion transmission between two adjacent vacuum chambers, while minimizing gas conductance between those chambers.

While most mass spectrometry analysis is conducted using sample ions having a positive charge, there are times when sample ions having a negative charge are also analyzed. The ion interface designs described herein will operate equally well using positive or negative ions. The primary difference being the manner in which the sample ions are created, and the polarity of the DC biasing voltages used in the flight path of the mass spectrometer sample inlet system.

In situations where ion dispersion is extreme for ions exiting the ion guide in the first vacuum chamber, the multiple aperture ion interface, or single aperture ion interface described herein, may actually be used to increase total ion transmission between chambers, while still maintaining an acceptable level of gas conductance.

1. A method of transferring ions from a first vacuum chamber, operated at a first gas pressure, to a second vacuum chamber, operated at a second and lower gas pressure, by passing said ions through a surface comprising a plurality of individual apertures.

2. The method of claim 1 in which said plurality of individual apertures have a tapered structure, in which the entrance side of said plurality of individual apertures facing said first vacuum chamber has a smaller area than the exit side of said plurality of individual apertures facing said second vacuum chamber.

3. The method of claim 1 in which said plurality of individual apertures comprises a plurality of circular holes.

4. The method of claim 1 in which said plurality of individual apertures is arranged in a circular pattern.

5. The method of claim 1 in which said plurality of individual apertures are all approximately the same size.

6. The method of claim 1 in which said plurality of individual apertures comprises a single circular hole surrounded by a symmetrical arrangement of circular holes.

7. The method of claim 1 in which said plurality of individual apertures are equally spaced and located within a circular perimeter.

8. The method of claim 1 in which said plurality of individual apertures are randomly spaced and located within a circular perimeter.

9. An apparatus for transferring ions from a first vacuum chamber operated at a first gas pressure, to a second vacuum chamber operated at a second and lower gas pressure, comprising a surface containing a plurality of individual apertures.

10. The apparatus of claim 9 in which said plurality of individual apertures have a tapered structure, in which the entrance side of said plurality of individual apertures facing said first vacuum chamber has a smaller area than the exit side of said plurality of individual apertures facing said second vacuum chamber.

11. The apparatus of claim 9 in which said plurality of individual apertures comprises a plurality of circular holes.

12. The apparatus of claim 9 in which said plurality of individual apertures is arranged in a circular pattern.

13. The apparatus of claim 9 in which said plurality of individual apertures are all approximately the same size.

14. The apparatus of claim 9 in which said plurality of individual apertures comprises a single circular hole surrounded by a symmetrical pattern of circular holes.

15. The apparatus of claim 9 in which said plurality of individual apertures are equally spaced within a circular perimeter.

16. The apparatus of claim 9 in which said plurality of individual apertures are randomly spaced within a circular perimeter.

17. A method of transferring ions from a first vacuum chamber, operated at a first gas pressure, to a second vacuum chamber, operated at a second and lower gas pressure, by passing said ions through an ion interface device comprising a single aperture, where said single aperture shape comprises a contiguous collection of individual aperture shapes.

18. The method of claim 17 in which said single aperture has the shape of a plurality of contiguous shapes selected from the group consisting of circular, square, rectangular, elliptical, triangular, and polygon.
